(19) United States
(12) Patent Application Publication
(10) Pub. No.: US 2025/0199238 A1
(43) Pub. Date: Jun. 19, 2025

(54) OPTICAL MODULE AND OPTOELECTRONIC SUBSTRATE

(71) Applicant: SUMITOMO ELECTRIC INDUSTRIES, LTD., Osaka (JP)

(72) Inventors: Hiroshi UEMURA, Osaka (JP); Yasutaka MIZUNO, Osaka (JP); Katsumi UESAKA, Osaka (JP)

(21) Appl. No.: 18/976,484

(22) Filed: Dec. 11, 2024

(30) Foreign Application Priority Data
Dec. 15, 2023 (JP) 2023-212248

(51) Int. Cl. G02B 6/12; G02B 6/42

(52) U.S. Cl. CPC G02B 6/12004; G02B 6/4214; G02B 2006/12038; G02B 2006/121; G02B 2006/12104

(57) ABSTRACT

An optical module according to one embodiment includes an optoelectronic substrate including a first surface, a first recess open on the first surface, a first waveguide extending toward the first recess, and a first mirror that is formed inside the first recess and that reflects a signal light transmitted through the first waveguide; and an optical IC including a circuit surface facing the first surface, a second waveguide formed on the circuit surface, a second recess open on the circuit surface, and a second mirror that is formed inside the second recess and that reflects the signal light transmitted through the second waveguide, and connected to the optoelectronic substrate such that the circuit surface faces the first surface. The first waveguide and the second waveguide are optically coupled to each other through the first mirror and the second mirror.

### CROSS-REFERENCE TO RELATED APPLICATION

This application claims priority from Japanese Patent Application No. 2023-212248, filed on Dec. 15, 2023, the entire subject matter of which is incorporated herein by reference.

### TECHNICAL FIELD

The present disclosure relates to an optical module and an optoelectronic substrate.

### BACKGROUND

U.S. Unexamined Patent Publication No. 2021/0271037 describes an optoelectronic assembly including an optoelectronic substrate on which an optical connector and an optical IC is mounted. The optoelectronic substrate includes a glass optical waveguide extending from the optical connector to an overlapping region. The optical IC has a waveguide region extending from the overlapping region to a photoelectric conversion unit. The optoelectronic substrate includes a rewiring layer electrically connected to the photoelectric conversion unit, and a conductive via extending downward from the rewiring layer. The glass optical waveguide of the optoelectronic substrate and the waveguide region of the optical IC are optically coupled to each other in the overlapping region.

Japanese Unexamined Patent Publication No. 2002-174744 describes an optical component mounting substrate including a glass substrate. The optical component mounting substrate is mounted on a printed circuit board, and converts an electrical signal from the printed circuit board into an optical signal. A via hole is formed in the glass substrate, and the via hole is filled with resin. The glass substrate is coated with a lower cladding, a core, and a photoresist, and the photoresist is exposed and developed using a waveguide pattern mask. Then, the core is patterned by reactive ion etching to have a rectangular cross section, and then the photoresist is removed. A mirror is formed at a predetermined location in the core, and an upper cladding and an optical wiring layer are formed in order on the core. The mirror is formed by processing the core diagonally at an angle of 45° using a laser or the like.

### SUMMARY

An optical module according to the present disclosure includes an optoelectronic substrate including a first surface, a first recess open on the first surface, a first waveguide extending toward the first recess, and a first mirror that is formed inside the first recess and that reflects a signal light input transmitted through the first waveguide; and an optical IC including a circuit surface facing the first surface, a second waveguide formed on the circuit surface, a second recess open on the circuit surface, and a second mirror that is formed inside the second recess and that reflects the signal light transmitted through the second waveguide, and connected to the optoelectronic substrate such that the circuit surface faces the first surface. The first waveguide and the second waveguide are optically coupled to each other through the first mirror and the second mirror.

### BRIEF DESCRIPTION OF THE DRAWINGS

FIG. 1 is a cross-sectional view showing an optical module according to an embodiment.

FIG. 2 is a plan view showing the optical module according to the embodiment.

FIG. 3 is a cross-sectional view showing an optoelectronic substrate and an optical IC of the optical module according to the embodiment.

FIG. 4 is a plan view showing the optoelectronic substrate and the optical IC of the optical module according to the embodiment.

FIG. 5 is a cross-sectional view showing an optoelectronic substrate including a first mirror and an optical IC including a second mirror according to a first modification example.

FIG. 6 is a cross-sectional view showing an optoelectronic substrate including a first mirror and an optical IC including a second mirror according to a second modification example.

FIG. 7 is a plan view showing an optoelectronic substrate and an optical IC of an optical module according to a third modification example.

FIG. 8 is a cross-sectional view showing the optoelectronic substrate including a first mirror and the optical IC including the second mirror according to the third modification example.

FIG. 9 is a cross-sectional view showing an optical module according to a fourth modification example.

FIG. 10 is a plan view showing an optical module according to a further modification example.

### DETAILED DESCRIPTION

Incidentally, in an optical module including an optoelectronic substrate such as a glass substrate may require a long optical path length to suppress optical coupling loss. An example of a case where a long optical path length is required is optical coupling using evanescent coupling. In this case, the optical module and the optoelectronic substrate become large, which is a risk. Therefore, there has been a demand for being able to realize downsizing of the optical module and the optoelectronic substrate through high-density mounting of optical ICs to be mounted on the optoelectronic substrate.

An object of the present disclosure is to provide an optical module and an optoelectronic substrate capable of high-density mounting of optical ICs and reducing optical coupling loss.

According to the present disclosure, the optical ICs can be mounted at high density, and optical coupling loss can be reduced.

### Description of Embodiment of Present Disclosure

First, embodiments of an optical module and an optoelectronic substrate according to the present disclosure will be listed and described.
(1) An optical module according to one embodiment includes an optoelectronic substrate including a first surface, a first recess open on the first surface, a first waveguide extending toward the first recess, and a first mirror that is formed inside the first recess and that reflects a signal light transmitted through the first waveguide; and an optical IC including a circuit surface facing the first surface, a second waveguide formed on the circuit surface, a second recess open on the circuit surface, and a second mirror that is formed inside the second recess and that reflects a signal light transmitted through the second waveguide, and connected to the optoelectronic substrate such that the circuit surface faces the first surface. The first waveguide and the second waveguide are optically coupled to each other through the first mirror and the second mirror.
(7) An optoelectronic substrate according to one embodiment is an optoelectronic substrate connected to an optical IC. The optoelectronic substrate includes a first surface facing a circuit surface of the optical IC; a first recess open on the first surface; a first waveguide extending toward the first recess; and a first mirror that is formed inside the first recess, and that reflects a signal light transmitted through the first waveguide.
(8) An optoelectronic substrate according to another embodiment is an optoelectronic substrate having a first surface and a second surface opposite to the first surface. The optoelectronic substrate includes a first glass substrate having the first surface, and a second glass substrate having the second surface. The first glass substrate includes a first recess, a first waveguide, a first mirror, and a first terminal, the first recess being open on the first surface, the first waveguide extending toward the first recess, the first mirror being formed inside the first recess and configured to reflect a signal light transmitted through the first waveguide, the first terminal being formed on the first surface. The second glass substrate includes the second surface and a second terminal formed on the second surface. A wiring path is formed in the first glass substrate and the second glass substrate, the wiring path is configured to electrically connect the first terminal and the second terminal each other.

The optoelectronic substrate of the optical module has the first surface facing the circuit surface of the optical IC, and the first recess is formed on the first surface. The optoelectronic substrate includes the first waveguide, and the first waveguide extends toward the first recess. The first mirror is formed inside the first recess, and the first mirror reflects the signal light transmitted through the first waveguide. The first mirror is disposed inside the first recess to which the first waveguide extends, and the first mirror reflects the signal light transmitted through the first waveguide, so that the optical path of the signal light can be made compact. Therefore, the downsizing of the optical module and the optoelectronic substrate can be realized through high-density mounting of the optical ICs to be mounted on the optoelectronic substrate.
(2) In the above (1), the optoelectronic substrate may be configured by laminating a plurality of glass substrates. The first surface may be an upper surface of the glass substrate in an uppermost layer among the plurality of glass substrates, and the first waveguide may be formed in the glass substrate in the uppermost layer. In this case, when the optoelectronic substrate is mounted on a wiring substrate, a pitch of electrodes on the wiring substrate can be easily matched to a pitch of electrodes on the optical IC between the plurality of glass substrates. Further, when the plurality of glass substrates are laminated, the first surface that is the upper surface of the glass substrate in the uppermost layer can be made less likely to warp. Therefore, the optical IC can be easily mounted on the optoelectronic substrate.
(3) In the above (1) or (2), the signal light may be output from the first waveguide into the first recess, and the signal light may be reflected toward the optical IC by the first mirror. The second mirror may reflect the signal light, which is reflected by the first mirror, toward the second waveguide. In this case, the signal light propagating through the first waveguide of the optoelectronic substrate can be reflected toward the optical IC by the first mirror disposed inside the first recess. Then, the signal light reflected by the first mirror is reflected toward the second waveguide of the optical IC by the second mirror, so that the first waveguide can be optically coupled to the second waveguide.
(4) In the above (3), the second mirror may reflect the signal light such that a direction of the signal light propagating through the second waveguide becomes the same as a direction of the signal light propagating through the first waveguide.
(5) In any one of the above (1) to (4), the optoelectronic substrate may have an end face intersecting the first surface, and the first waveguide may extend from the end face toward the first recess. The optical module may further include an optical fiber that is connected to the end face and that is optically coupled to the first waveguide. In this case, the optical fiber located outside the optoelectronic substrate can be optically coupled to the first waveguide.
(6) In any one of the above (1) to (5), the optoelectronic substrate may include a plurality of the first recesses, a plurality of the first waveguides extending toward the plurality of respective first recesses, and a plurality of the first mirrors formed inside the plurality of respective first recesses. The optical IC may include a plurality of the second recesses, the second waveguide extending between the plurality of second recesses, and a plurality of the second mirrors formed inside the plurality of respective second recesses. The plurality of first waveguides may be optically coupled to each other through the plurality of first mirrors, the plurality of second mirrors, and the second waveguide.

### Details of Embodiment of Present Disclosure

Specific examples of an optical module and an optoelectronic substrate according to an embodiment will be described below with reference to the drawings. Note that, it is intended that the present invention is not limited to the following examples and includes all modifications within the scope of the claims and equivalents to the claims. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

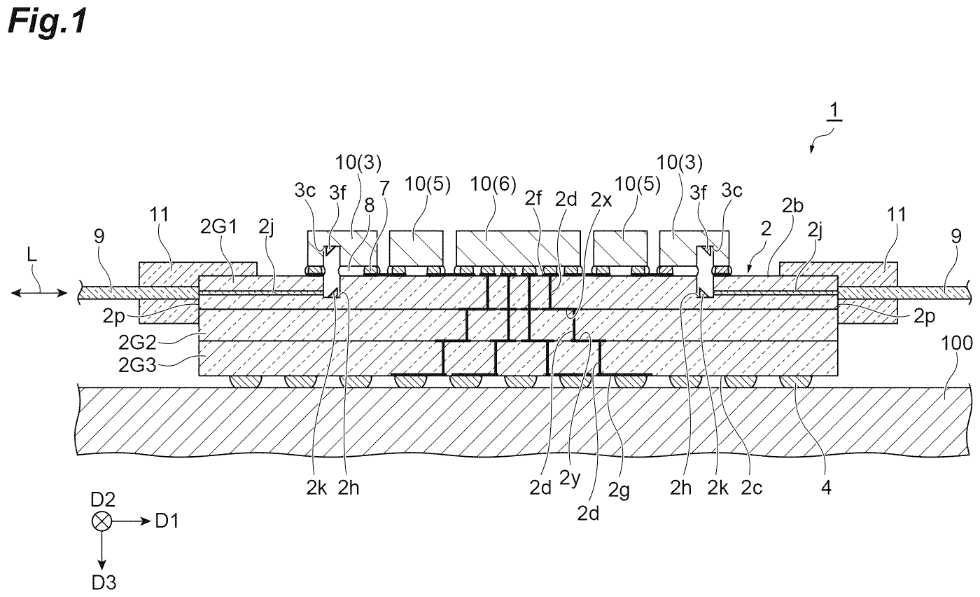

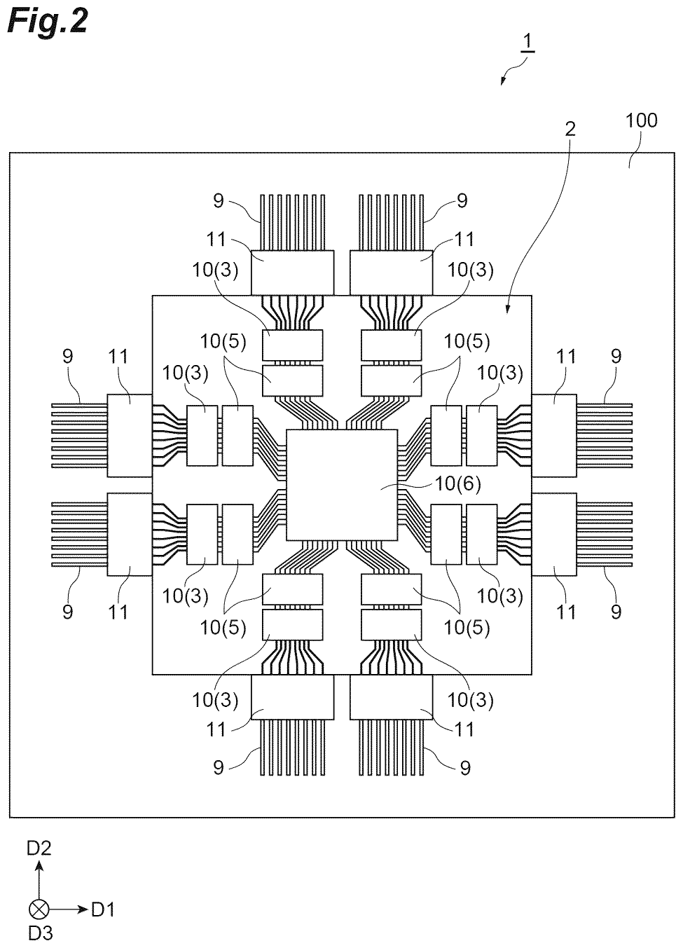

FIG. 1 is a cross-sectional view showing an optical module 1 according to the present embodiment. FIG. 2 is a plan view showing the optical module 1. As shown in FIGS. 1 and 2, the optical module 1 includes an optoelectronic substrate 2 and an optical integrated circuit (IC) 3. The optical module 1 is, for example, a switch circuit module of which the input and output are optical signals. For example, the optical module 1 is a switch circuit module for Ethernet signals.

The optoelectronic substrate 2 has a first surface 2b extending in both a first direction D1 and a second direction D2, and a second surface 2c facing opposite to the first surface 2b and extending in both the first direction D1 and the second direction D2. The optoelectronic substrate 2 is configured by laminating a plurality of glass substrates 2G. The plurality of glass substrates 2G are laminated, for example, using an adhesive (not shown). For example, the optoelectronic substrate 2 includes three glass substrates 2G1, 2G2, and 2G3. The glass substrate 2G1 is an example of a first grass substrate. The glass substrate 2G3 is an example of a second grass substrate. The glass substrate 2G2 may be excluded. In such a case, the glass substrate 2G1 may be bonded directly on the glass substrate 2G3. The three glass substrates 2G1, 2G2, and 2G3 provide a higher flexibility in wiring than two glass substrates 2G1, and 2G3. The optoelectronic substrate 2 in which the plurality of glass substrates 2G are laminated is, for example, a glass interposer. The glass substrates 2G extend in the first direction D1 and the second direction D2 intersecting the first direction D1. The glass substrates 2G have a thickness in a third direction D3 intersecting both the first direction D1 and the second direction D2. The glass substrates 2G may be made of, for example, any one of borosilicate glass, non-alkali glass, aluminosilicate glass, crystallized glass, quartz glass, and soda-lime glass.

For example, a main component of the glass constituting the glass substrates 2G is silicon dioxide (SiO₂). The glass substrates 2G may be a composition containing at least one of boron oxide (B₂O₃), alumina (Al₂O₃), sodium (Na), and calcium (Ca). A linear expansion coefficient of the glass substrates 2G is, for example, 3 to 5 [ppm/K]. However, the linear expansion coefficient of the glass substrates 2G can be set to approximately 1 [ppm/K] or less or approximately 10 [ppm/K] or more by adjusting the composition of a material constituting the glass.

The glass substrates 2G include a via 2d extending in the third direction D3 and penetrating through the glass substrates 2G. The via 2d is also referred to as a through glass via (TGV). The via 2d has, for example, a columnar shape. The glass substrates 2G include a plurality of the vias 2d. The plurality of vias 2d are aligned, for example, along each of the first direction D1 and the second direction D2. For example, in a plan view of the optoelectronic substrate 2, the vias 2d may be arranged two-dimensionally at a constant pitch.

The vias 2d are filled with, for example, metal (also referred to as filled vias). As a specific example, the vias 2d are filled with copper (Cu). However, the vias 2d may not be completely filled with metal. For example, each of the vias 2d may be configured such that a metal film is formed only on a side wall surface and the center is hollow (also referred to as a conformal via).

The optoelectronic substrate 2 includes, for example, an electrical wiring 2f formed on the first surface 2b; an electrical wiring 2x formed between the glass substrate 2G1 and the glass substrate 2G2; an electrical wiring 2y formed between the glass substrate 2G2 and the glass substrate 2G3; and an electrical wiring 2g formed on the second surface 2c. The electrical wirings 2f, 2g, 2x, and 2y are, for example, thin films made of copper. The surfaces of the electrical wirings 2f, 2g, 2x, and 2y may be plated with gold (Au). In addition, the electrical wirings 2f, 2g, 2x, and 2y may be formed by plating nickel (Ni) or palladium (Pd) between the gold plating and the copper. The electrical wirings 2f, 2g, 2x, and 2y can also be used as electrodes or pads. The electrical wiring 2f and the electrical wiring 2x are electrically connected to each other through the vias 2d in the glass substrate 2G1. The electrical wiring 2x and the electrical wiring 2y are electrically connected to each other through the vias 2d in the glass substrate 2G2. The electrical wiring 2y and the electrical wiring 2g are electrically connected to each other through the vias 2d in the glass substrate 2G3. The electrical wirings 2f, 2g, 2x, 2y and the vias 2d form a wiring path which electrically connects the terminal 4 and terminal 7 each other. The electrical wirings 2x, 2y may be merged, when the optoelectronic substrate 2 includes only two glass substrates 2G1, and 2G3. In such a case, the wiring path is formed in two glass substrates 2G1, and 2G3. The optoelectronic substrate 2 has a first surface 2b and a first surface 2c opposite to the second surface 2b. For example, the glass substrates 2G1 (first glass substrates) have a first surface 2b, and the glass substrates 2G3 (second glass substrates) have a second surface 2c. A glass substrate 2G1 is provided with a first concave portion 2h which opens to a first surface 2b, a first wave guide 2j which extends toward the first concave portion 2h, a first mirror 2k which is formed in the first concave portion 2h and reflects a signal light L propagating in the first wave guide 2j, and terminals 7 (first terminals) formed on the first surface 2b. The glass substrate 2G3 has terminals 4 (second terminals) formed on the second surface 2c. The glass substrate 2G1 and the glass substrate 2G3 are formed with wirings for electrically connecting the terminals 4 and 7 to each other. As shown in FIG. 1, the optoelectronic substrate 2 may further include a glass substrate 2G2 between the glass substrates 2G1 and 2G3. For example, the glass substrate 2G2 is bonded on the glass substrate 2G3, and the glass substrate 2G1 is bonded on the glass substrate 2G2. In this way, the glass substrates 2G1, 2G2, and 2G3 are stacked along the third direction D3. The third direction D3 is also referred to as a stacking direction. The stacking direction may coincide with the normal direction of the first surface 2b and the second surface 2c. In the optoelectronic substrate 2 shown in FIG. 1, the wirings for electrically connecting the terminals 4 and 7 to each other are constituted by, for example, the above-mentioned electric wirings 2f, 2g, 2x, 2y and the via 2d. For example, when the opto-electric substrate 2 does not include the glass substrate 2G2, the electric wirings 2x and 2y may be merged with each other. As the number (number of layers) of the plurality of glass substrates included in the optoelectronic substrate 2 increases, the three dimensional intersection between the plurality of wirings formed inside becomes easier, and the degree of freedom of the wirings can be improved and the integration density of the wirings can be improved.

For example, the optical module 1 is surface-mounted on an external wiring substrate 100. In the following description, a direction in which the optical module 1 is provided when viewed from the wiring substrate 100 may be referred to as the top, upper side, or upward, and a direction in which the wiring substrate 100 is provided when viewed from the optical module 1 may be referred to as the bottom, lower side, or downward. However, these directions are for convenience of description, and do not limit the disposition positions or directions of objects.

For example, the optical module 1 includes a terminal 4 for external connection. The terminal 4 is an example of a second terminal. The terminal 4 is provided on the second surface 2c of the optoelectronic substrate 2. The terminal 4 is a solder ball having a spherical shape. As one example, the terminal 4 is, for example, an Sn—Ag—Cu alloy solder. The terminal 4 is connected to the electrical wiring 2g formed on the second surface 2c of the optoelectronic substrate 2. The optical module 1 includes a plurality of the terminals 4, and for example, the plurality of terminals 4 are aligned along the first direction D1 and the second direction D2. The terminals 4 may be arranged in an array. A disposition interval (pitch) of the terminals 4 arranged in an array is, for example, 0.5 mm. For example, the plurality of terminals 4 form a ball grid array (BGA). The terminals 4 are interposed between the optoelectronic substrate 2 and the wiring substrate 100. The terminals 4 electrically connect an electrical wiring of the wiring substrate 100 and the electrical wiring 2g of the optoelectronic substrate 2 to each other.

For example, the optical module 1 includes a plurality of integrated circuits 10 mounted on the optoelectronic substrate 2. In the present embodiment, the plurality of integrated circuits 10 are at least one optical IC 3, at least one electrical IC 5, and at least one large-scale integration (LSI) 6. In a plan view (when viewed along the third direction D3), a plurality of the electrical ICs 5 are disposed to surround the LSI 6, and a plurality of the optical ICs 3 are disposed to surround the plurality of electrical ICs 5.

The optical IC 3 is, for example, a modulator or a photodiode. The electrical IC 5 is, for example, a driver or a trans impedance amplifier

(TIA). The electrical IC 5 is, for example, a front-end IC for the optical IC 3. If the electrical IC 5 is a driver, the electrical IC 5 drives the optical IC 3 that is, for example, a modulator. If the electrical IC 5 is a TIA, the electrical IC 5 converts an output current of the optical IC 3, which is, for example, a photodiode, into a voltage and amplifies the voltage. The LSI 6 is, for example, an Ethernet switch. The plurality of integrated circuits 10 are flip-chip mounted on the optoelectronic substrate 2. Namely, the integrated circuits 10 are mounted in a state where circuit surfaces thereof face the optoelectronic substrate 2. Note that, the types of the integrated circuits 10 are not limited to the electrical IC 5 and the LSI 6 described above, and can be changed as appropriate. The electrical ICs 5 are interposed between the optical ICs 3 and the LSI 6. The electrical ICs 5 can also be omitted, for example, when the LSI 6 includes the function of the electrical ICs 5 or when the optical ICs 3 includes the function of the electrical ICs 5.

The optical module 1 includes an underfill resin 8 with which gaps between the optoelectronic substrate 2 and the integrated circuits 10 are filled. For example, the underfill resin 8 contains a filler. A region between the optoelectronic substrate 2 and the integrated circuits 10 is filled with the underfill resin 8 by capillary action. The underfill resin 8 stops just before a first recess 2h of the optoelectronic substrate 2 to be described later and a second recess 3c of the optical IC 3 due to surface tension. Note that, the underfill resin 8 can also be omitted.

The optical module 1 includes a terminal 7 that electrically connects the integrated circuit 10 to the optoelectronic substrate 2. The terminal 7 is an example of a first terminal. The terminal 7 is provided on the first surface 2b of the optoelectronic substrate 2. The terminal 7 is a solder ball having a spherical shape. Similarly to the terminals 4, the terminal 7 may be a Su-Ag-Cu alloy solder. The terminal 7 is connected to the electrical wiring 2f formed on the first surface 2b of the optoelectronic substrate 2. The optical module 1 may include a plurality of the terminals 7. The terminals 7 may be arranged in an array. A disposition interval of the terminals 7 arranged in an array is, for example, 0.1 mm.

For example, the disposition interval of the terminals 4 is larger than the disposition interval of the terminals 7. Accordingly, the vias 2d have different disposition intervals in the plurality of glass substrates 2G. Specifically, the disposition interval of the vias 2d in the glass substrate 2G3 close to the terminals 4 (for example, adjacent to the wiring substrate 100) is larger than the disposition interval of the vias 2d in the glass substrate 2G1 close to the terminals 7 (for example, adjacent to the integrated circuits 10). The disposition interval of the vias 2d in the glass substrate 2G3 in a lowermost layer is larger than the disposition interval of the vias 2d in the glass substrate 2G2 located second from the bottom. The disposition interval of the vias 2d in the glass substrate 2G1 in an uppermost layer is smaller than the disposition interval of the vias 2d in the glass substrate 2G2 located second from the top. In such a manner, by providing the plurality of glass substrates 2G in the optoelectronic substrate 2, the pitch of the terminals 4 of the wiring substrate 100 can be easily matched to the pitch of the terminals 7 of the integrated circuits 10.

The optoelectronic substrate 2 includes the first recess 2h open on the first surface 2b; a first waveguide 2j extending toward the first recess 2h; and a first mirror 2k that is formed inside the first recess 2h and that reflects a signal light L input to and output from the first waveguide 2j. The signal light L is transmitted through the first waveguide 2j. For example, the optoelectronic substrate 2 includes a plurality of the first recesses 2h aligned along the first direction D1; a plurality of the first waveguides 2j aligned along the first direction D1; and a plurality of the first mirrors 2k aligned along the first direction D1. For example, the first surface 2b is an upper surface of the glass substrate 2G1 in the uppermost layer among the plurality of glass substrates 2G, and the first waveguides 2j are formed in the glass substrate 2G1 in the uppermost layer.

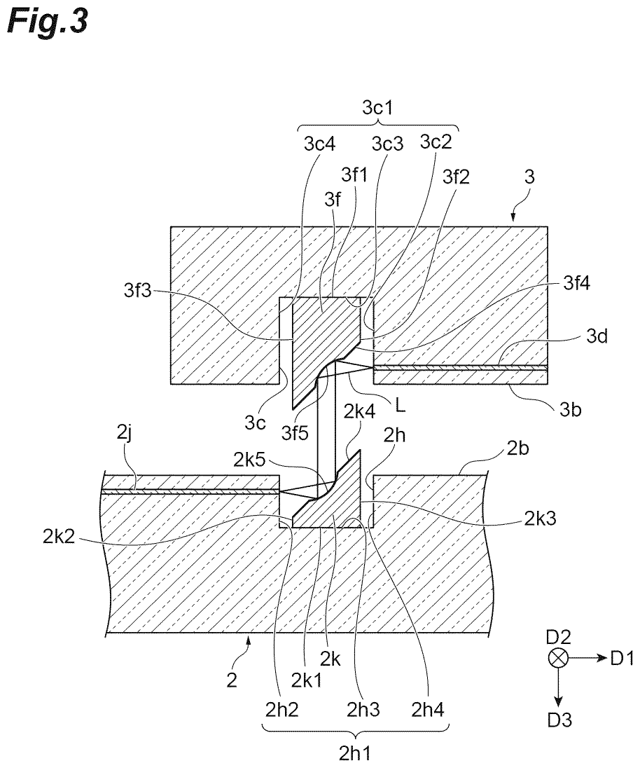

The optoelectronic substrate 2 has an end face 2p intersecting the first surface 2b. The end face 2p extends in both the second direction D2 and the third direction D3 at an end portion of the optoelectronic substrate 2 in the first direction D1. The first waveguide 2j extends from the end face 2p toward the first recess 2h. Namely, the first waveguide 2j extends from the end face 2p to an inner surface 2h1 (refer to FIG. 3) of the first recess 2h. The first waveguide 2j is a glass waveguide. There may be a distance between an end portion of the first waveguide 2j and the inner surface 2h1 of the first recess 2h. The distance between the end portion of the first waveguide 2j and the inner surface 2h1 of the first recess 2h is, for example, 0.1 mm. In addition, the first waveguide 2j that is a glass waveguide is formed, for example, at the position of a depth of 100 μm from a front surface (the first surface 2b) of the glass substrate 2G1. When the electrical wiring 2f to be described later is formed on the front surface of the glass substrate 2G1, it becomes easier to suppress an increase in the waveguide loss of the first waveguide 2j compared to when the first waveguide 2j is formed on the front surface of the glass substrate 2G1. Accordingly, the degree of freedom in designing the electrical wiring 2f can be improved. The depth at which the first waveguide 2j is formed is, for example, in a range of 50 μm or more and 200 μm or less from the front surface of the glass substrate 2G1.

For example, the optical module 1 includes optical fibers 9 and an optical fiber array 11 that holds the optical fiber 9. The optical fiber array 11 holds a plurality of the optical fibers 9. For example, the optical fiber array 11 may include a V-groove substrate on which a plurality of V-grooves on which the respective optical fibers 9 are placed are formed, and a lid that covers the V-groove substrate. In addition, the optical fiber array 11 may be a ferrule having a plurality of optical fiber holding holes through which the respective optical fibers 9 pass.

As one example, each of the optical fibers 9 is a single-core single-mode fiber. The optical fiber 9 may be, for example, a polarization-maintaining fiber. However, the optical fiber 9 may be a multi-core fiber or may be a multi-mode fiber. In the optical fiber array 11, the plurality of optical fibers 9 are arranged along the first direction DI (or the second direction D2).

The first waveguide 2j of the optoelectronic substrate 2 is optically coupled to the optical IC 3. FIG. 3 is a schematic enlarged cross-sectional view of an optical system including the optoelectronic substrate 2 and the optical IC 3. As shown in FIG. 3, the optical IC 3 has a circuit surface 3b facing the first surface 2b of the optoelectronic substrate 2; the second recess 3c open on the circuit surface 3b; a second waveguide 3d formed on the circuit surface 3b; and a second mirror 3f that is formed inside the second recess 3c and that reflects a signal light L input to and output from the second waveguide 3d. The signal light L is transmitted through the second waveguide 3d. The optical IC 3 is connected to the optoelectronic substrate 2 with the circuit surface 3b facing the first surface 2b of the optoelectronic substrate 2. The first waveguide 2j and the second waveguide 3d are optically coupled to each other through the first mirror 2k and the second mirror 3f. The second mirror 3f reflects the signal light L such that the signal light L propagating through the second waveguide 3d has the same direction as a direction in which signal light L propagates through the first waveguide 2j. Note that, the second mirror 3f may reflect the signal light L such that the signal light L propagating through the second waveguide 3d has a direction different from the direction in which the signal light L propagates through the first waveguide 2j.

The inner surface 2h1 of the first recess 2h of the optoelectronic substrate 2 includes an inner side surface 2h2 on which the first waveguide 2j is formed; a bottom surface 2h3 to which the first mirror 2k is fixed; and an inner side surface 2h4 facing the inner side surface 2h2 along the first direction D1. The first recess 2h is defined by the inner side surface 2h2, the bottom surface 2h3, and the inner side surface 2h4. The first mirror 2k has, for example, a fixed surface 2k1 fixed to the bottom surface 2h3; an outer side surface 2k2 facing the inner side surface 2h2; an outer side surface 2k3 facing the inner side surface 2h4; and an inclined surface 2k4 extending diagonally downward from an upper end of the outer side surface 2k3 to an upper end of the outer side surface 2k2. The first mirror 2k has a reflecting surface 2k5 that reflects the signal light L. The reflecting surface 2k5 is formed on the inclined surface 2k4. The reflecting surface 2k5 has a concave shape on the inclined surface 2k4. For example, the reflecting surface 2k5 is coated with a metal film. As one example, the material of the metal film is gold.

An inner surface 3c1 of the second recess 3c of the optical IC 3 includes an inner side surface 3c2 on which the second waveguide 3d is formed; a bottom surface 3c3 to which the second mirror 3f is fixed; and an inner side surface 3c4 facing the inner side surface 3c2 along the first direction D1. The second recess 3c is defined by the inner side surface 3c2, the bottom surface 3c3, and the inner side surface 3c4. The second mirror 3f has, for example, a fixed surface 3f1 fixed to the bottom surface 3c3; an outer side surface 3f2 facing the inner side surface 3c2; an outer side surface 3f3 facing the inner side surface 3c4; and an inclined surface 3f4 extending diagonally upward from a lower end of the outer side surface 3f3 to a lower end of the outer side surface 3f2. The second mirror 3f has a reflecting surface 3f5 that reflects the signal light L. The reflecting surface 3f5 is formed on the inclined surface 3f4. The reflecting surface 3f5 has a concave shape on the inclined surface 3f4. For example, similarly to the reflecting surface 2k5, the reflecting surface 3f5 is coated with a metal film. A curvature of the reflecting surface 3f5 may be different from a curvature of the reflecting surface 2k5.

For example, the first mirror 2k is a concave mirror having the reflecting surface 2k5 having a concave shape, and the second mirror 3f is a concave mirror having the reflecting surface 3f5 having a concave shape. When the signal light L is output from the first waveguide 2j into the first recess 2h, the signal light L is reflected toward the optical IC 3 by the first mirror 2k, and the second mirror 3f reflects the signal light L, which is reflected by the first mirror 2k, toward the second waveguide 3d. More specifically, when the signal light L is output as a divergent light from the first waveguide 2j into the first recess 2h, the divergent light is converted into a collimated light by the reflecting surface 2k5 of the first mirror 2k, and is reflected toward the second mirror 3f. The collimated light reflected toward the second mirror 3f is converted into a converging light by the reflecting surface 3f5 of the second mirror 3f, and is reflected toward the second waveguide 3d.

In addition, when the signal light L is output from the second waveguide 3d into the second recess 3c, the signal light L is reflected toward the optoelectronic substrate 2 by the second mirror 3f, and the first mirror 2k reflects the signal light L, which is reflected by the second mirror 3f, toward the first waveguide 2j. More specifically, when the signal light L is output as a divergent light from the second waveguide 3d into the second recess 3c, the divergent light is converted into a collimated light by the reflecting surface 3f5 of the second mirror 3f, and is reflected toward the first mirror 2k. The collimated light reflected toward the first mirror 2k is converted into a converging light by the reflecting surface 2k5 of the first mirror 2k, and is reflected toward the first waveguide 2j. Since the optoelectronic substrate 2 is a glass interposer, the optoelectronic substrate 2 is less likely to warp and has a smaller linear expansion coefficient than an organic interposer. For that reason, stable optical coupling can be realized between the first waveguide 2j and the second waveguide 3d.

For example, a length of the first mirror 2k in the first direction D1, a length of the first mirror 2k in the second direction D2, and a length of the first mirror 2k in the third direction D3 are 300 μm or less. The length of the first mirror 2k in the first direction D1, the length of the first mirror 2k in the second direction D2, and the length of the first mirror 2k in the third direction D3 may be 100 μm or less (as one example, 50 μm). For example, an angle of the inclined surface 2k4 with respect to the fixed surface 2k1 is 30° or more and 60° or less. A radius of curvature of the reflecting surface 2k5 is, for example, 10 μm or more and 300 μm or less. The material of the first mirror 2k is, for example, resin or glass. For example, a beam diameter of a collimated light converted by the reflecting surface 2k5 is 10 μm or more and 100 μm or less, and a distance by which the collimated light propagates is 10 μm or more and 200 μm or less.

A length of the first recess 2h in the first direction D1 is 100 μm or more and 500 μm or less, and a length of the first recess 2h in the second direction D2 is 100 μm or more and 500 μm or less. A length (depth) of the first recess 2h in the third direction D3 is 10 μm or more and 300 μm or less. A plurality of the first mirrors 2k may be arranged along the second direction D2. In this case, a pitch of the first mirrors 2k arranged along the second direction D2 is, for example, 10 μm or more and 300 μm or less. The pitch of the first mirrors 2k may be the same as a pitch of the plurality of optical fibers 9 arranged along the second direction D2. When the plurality of the first mirrors 2k are arranged, the plurality of first recesses 2h may be formed for the respective first mirror 2k, or one first recess 2h in which the plurality of first mirrors 2k are disposed may be formed. Examples of the length, angle, and fixing method of each portion of the first mirror 2k and the first recess 2h have been described above. The second mirror 3f and the second recess 3c of the optical IC 3 can also be configured as in the above example. Note that, the shapes of the first mirror 2k and the second mirror 3f may be the same or may be different.

The examples of the first mirror 2k of the optoelectronic substrate 2 and the second mirror 3f of the optical IC 3 have been described above. However, the configuration of the first mirror 2k and the configuration of the second mirror 3f are not limited to the above-described examples. The example in which the first mirror 2k is fixed to the bottom surface 2h3 of the first recess 2h has been described above. However, the first mirror 2k may be fixed to the inner side surface 2h4, and the location where the first mirror 2k is fixed can be changed as appropriate. The same applies to the second mirror 3f.

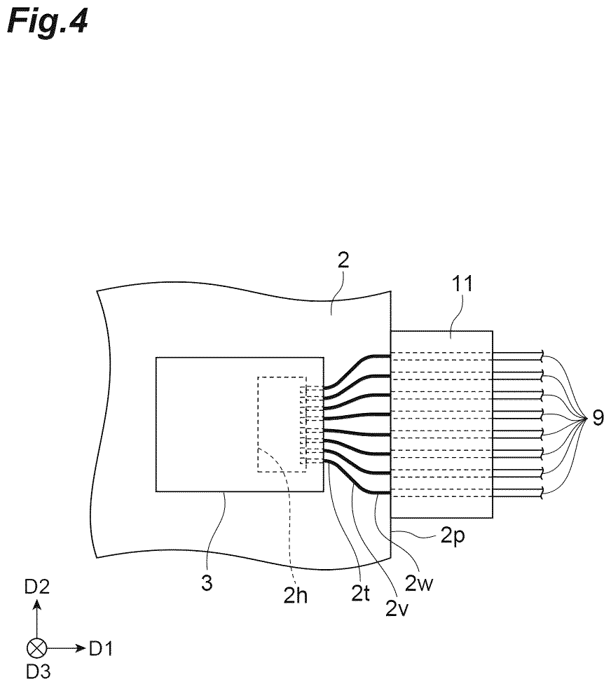

FIG. 4 is a view schematically showing the optical fibers 9, the optical fiber array 11, the optoelectronic substrate 2, and the optical IC 3 in a plan view. As shown in FIGS. 1 and 4, the first recess 2h of the optoelectronic substrate 2 is covered by the optical IC 3. Therefore, the entry of dust and the like into the first recess 2h can be suppressed, so that the reliability of optical coupling in the optoelectronic substrate 2 and the optical IC 3 can be improved. Further, as described above, the underfill resin 8 stops just before the first recess 2h and the second recess 3c due to surface tension. Accordingly, the entry of the underfill resin 8 into the first recess 2h and the second recess 3c can be suppressed, so that the reliability of optical coupling in the optoelectronic substrate 2 and the optical IC 3 can be further improved.

The first waveguides 2j and the glass portion of the optoelectronic substrate 2 (the glass substrates 2G) have transparency in the wavelength band (for example, 1.2 μm to 1.7 μm) of the signal light L used by the optical module 1. The first waveguides 2j have a higher refractive index than the glass portion of the optoelectronic substrate 2 located around the first waveguides 2j. Accordingly, the glass portion of the optoelectronic substrate 2 functions as a cladding, and the first waveguides 2j functions as cores. Then, the signal light L can be confined inside the first waveguides 2j functioning as cores. For example, the first waveguides 2j have approximately the same refractive index as cores of the optical fibers 9, and the glass portion of the optoelectronic substrate 2 has approximately the same refractive index as claddings of the optical fibers 9. The optical fibers 9 are connected to the end face 2p, and are optically coupled to the first waveguides 2j.

The optical module 1 includes the plurality of first waveguides 2j, and the plurality of first waveguides 2j are arranged along the first direction D1 (or the second direction D2). For example, the first waveguides 2j include first portions 2t extending from the optical IC 3 in a plan view; third portions 2w optically connected to the optical fibers 9 held in the optical fiber array 11; and second portions 2v that smoothly connect the first portions 2t to the third portions 2w. The pitch of the second portions 2v arranged along the second direction D2 (or the first direction D1) increases as the second portions 2v extend away from the first portions 2t.

Next, actions and effects obtained from the optical module 1 and the optoelectronic substrate 2 according to the present embodiment will be described. The optoelectronic substrate 2 of the optical module 1 has the first surface 2b facing the circuit surface 3b of the optical IC 3, and the first recess 2h is formed on the first surface 2b. The optoelectronic substrate 2 includes the first waveguide 2j, and the first waveguide 2j extends toward the first recess 2h. The first mirror 2k is formed inside the first recess 2h, and the first mirror 2k reflects the signal light L input to and output from the first waveguide 2j. The signal light L is transmitted through the first waveguide 2j. The first mirror 2k is disposed inside the first recess 2h to which the first waveguide 2j extends, and the first mirror 2k reflects the signal light L input to and output from the first waveguide 2j, so that loss can be reduced over a wider wavelength band compared to, for example, when a grating coupler is used for optical coupling. In addition, the first mirror 2k can be formed from resin. Resin has better processability than glass, and is easily processed into a three-dimensional shape. Accordingly, the mirror with low loss can be formed.

As described above, the optoelectronic substrate 2 may be configured by laminating the plurality of glass substrates 2G. The first surface 2b may be the first surface 2b of the glass substrate 2G1 in the uppermost layer among the plurality of glass substrates 2G, and the first waveguide 2j may be formed in the glass substrate 2G1 in the uppermost layer. In this case, when the optoelectronic substrate 2 is mounted on the wiring substrate 100, the pitch of the electrical wirings (for example, the terminals 4) of the wiring substrate 100 can be easily matched to the pitch of the electrical wirings (for example, the terminals 7) of the integrated circuits 10 between the plurality of glass substrates 2G. Further, since the first waveguide 2j is formed in the glass substrate 2G1 in the uppermost layer, the distance between the first waveguide 2j and the optical IC 3 is short, and an improvement in optical coupling efficiency can be easily realized. In addition, the degree of freedom in designing the electrical wirings 2x, 2y, and 2g or the vias 2d in the glass substrates 2G2 and 2G3 in layers below the glass substrate 2G1 can be improved. In addition, reliability can be improved by forming the first waveguide 2j and the first recess 2h only in a specific glass substrate among the plurality of glass substrates.

As described above, the signal light L may be output from the first waveguide 2j into the first recess 2h, and the signal light L may be reflected toward the optical IC 3 by the first mirror 2k. The second mirror 3f of the optical IC 3 may reflect the signal light L, which is reflected by the first mirror 2k, toward the second waveguide 3d. In this case, the signal light L propagating through the first waveguide 2j of the optoelectronic substrate 2 can be reflected toward the optical IC 3 by the first mirror 2k disposed inside the first recess 2h. Then, the signal light L reflected by the first mirror 2k is reflected toward the second waveguide 3d of the optical IC 3 by the second mirror 3f, so that the first waveguide 2j can be optically coupled to the second waveguide 3d. Since the optical coupling uses two mirrors, compact optical coupling can be realized compared to, for example, optical coupling using evanescent coupling. For example, in a plan view, the area required for optical coupling can be reduced compared to evanescent coupling. Therefore, the downsizing of the optical module 1 and the optical ICs 3 can be realized through high-density mounting of the optical ICs 3 to be mounted on the optoelectronic substrate 2. In addition, the second mirror 3f can be formed from resin. Resin has better processability than an inorganic material (for example, silicon or silicon dioxide) constituting the optical IC 3, and is easily processed into a three-dimensional shape. Accordingly, optical coupling with low loss can be realized.

As described above, the second mirror 3f may reflect the signal light L such that a direction of the signal light L propagating through the second waveguide 3d becomes the same as a direction of the signal light L propagating through the first waveguide 2j. In this case, the direction of the signal light L propagating through the second waveguide 3d can be made the same as the direction of the signal light L propagating through the first waveguide 2j.

As described above, the optoelectronic substrate 2 may have the end face 2p intersecting the first surface 2b, and the first waveguide 2j may extend from the end face 2p toward the first recess 2h. The optical module 1 may further include the optical fiber 9 that is connected to the end face 2p and that is optically coupled to the first waveguide 2j. In this case, the optical fiber 9 can be optically coupled to the first waveguide 2j of the optoelectronic substrate 2, and the signal light L can be transmitted to and received from the outside of the optical module 1 through the optical fiber 9.

Next, various modification examples of the optical module and the optoelectronic substrate according to the present disclosure will be described. Some configurations of optical modules and optoelectronic substrates according to the various modification examples are the same as some configurations of the optical module 1 and the optoelectronic substrate 2 described above. Therefore, hereinafter, descriptions that overlap with the descriptions of the optical module 1 and the optoelectronic substrate 2 will be omitted as appropriate by using the same reference signs.

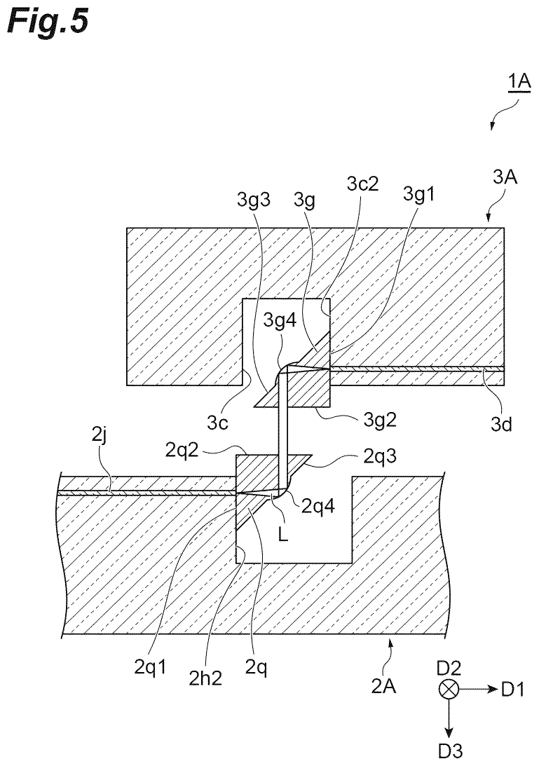

FIG. 5 is a cross-sectional view schematically showing an optoelectronic substrate 2A and an optical IC 3A of an optical module 1A according to a first modification example. As shown in FIG. 5, the optoelectronic substrate 2A includes a first mirror 2q different from the first mirror 2k described above, and the optical IC 3A includes a second mirror 3g different from the second mirror 3f described above.

The first mirror 2q has a fixed surface 2q1 fixed to the inner side surface 2h2 of the first recess 2h; an outer surface 2q2 facing the second recess 3c of the optical IC 3A; and an inclined surface 2q3 extending diagonally upward from a lower end of the fixed surface 2q1. The first mirror 2q has a reflecting surface 2q4 formed on the inclined surface 2q3. The reflecting surface 2q4 has a convex shape protruding from the inclined surface 2q3 to the outside of the first mirror 2q. The second mirror 3g has a fixed surface 3g1 fixed to the inner side surface 3c2 of the second recess 3c; an outer surface 3g2 facing the first recess 2h; and an inclined surface 3g3 extending diagonally downward from an upper end of the fixed surface 3g1. The second mirror 3g has a reflecting surface 3g4 formed on the inclined surface 3g3. The reflecting surface 3g4 has a convex shape protruding from the inclined surface 3g3 to the outside of the second mirror 3g.

When the signal light L is output as a divergent light from the first waveguide 2j to the first mirror 2q inside the first recess 2h, the divergent light is converted into a collimated light by the reflecting surface 2q4 of the first mirror 2q, and is reflected toward the second mirror 3g. The collimated light reflected toward the second mirror 3g is converted into a converging light by the reflecting surface 3g4 of the second mirror 3g, and is reflected toward the second waveguide 3d. In addition, when the signal light L is output as a divergent light from the second waveguide 3d to the second mirror 3g inside the second recess 3c, the divergent light is converted into a collimated light by the reflecting surface 3g4 of the second mirror 3g, and is reflected toward the first mirror 2q. The collimated light reflected toward the first mirror 2q is converted into a converging light by the reflecting surface 2q4 of the first mirror 2q, and is reflected toward the first waveguide 2j.

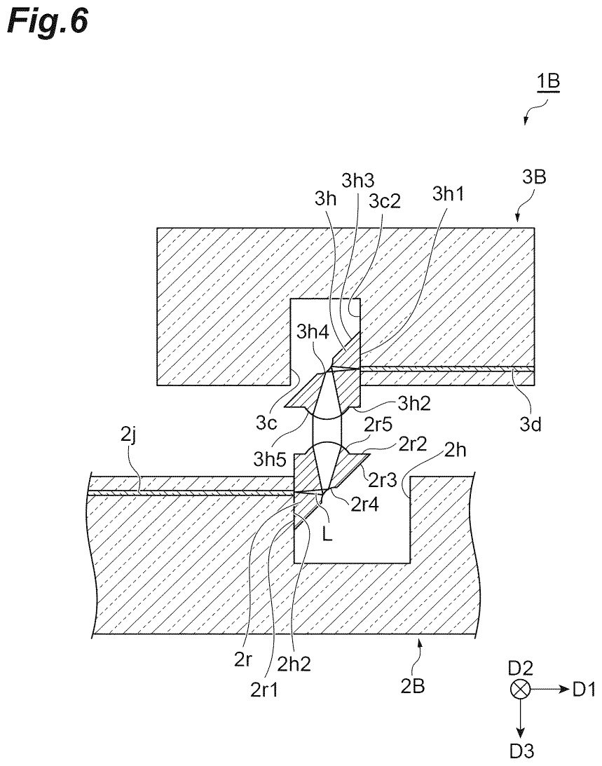

FIG. 6 is a cross-sectional view schematically showing an optoelectronic substrate 2B and an optical IC 3B of an optical module 1B according to a second modification example. As shown in FIG. 6, a first mirror 2r of the optoelectronic substrate 2B has a fixed surface 2r1 fixed to the inner side surface 2h2 of the first recess 2h; an outer surface 2r2 facing the second recess 3c of the optical IC 3B; and an inclined surface 2r3 extending diagonally upward from a lower end of the fixed surface 2r1. A reflecting surface 2r4 of the first mirror 2r has a concave shape recessed from the inclined surface 2r3 toward the inside of the first mirror 2r. The first mirror 2r includes a lens portion 2r5 having a convex shape protruding from the outer surface 2r2 to the outside of the first mirror 2r.

A second mirror 3h of the optical IC 3B has a fixed surface 3h1 fixed to the inner side surface 3c2 of the second recess 3c; an outer surface 3h2 facing the first recess 2h; and an inclined surface 3h3 extending diagonally downward from an upper end of the fixed surface 3h1. A reflecting surface 3h4 of the second mirror 3h has a concave shape recessed from the inclined surface 3h3 toward the inside of the second mirror 3h. The second mirror 3h includes a lens portion 3h5 protruding from the outer surface 3h2 to the outside of the second mirror 3h.

When the signal light L is output as a divergent light from the first waveguide 2j to the first mirror 2r inside the first recess 2h, the divergent light is increased in beam diameter by the reflecting surface 2r4 of the first mirror 2r, and is reflected toward the lens portion 2r5. The divergent light reflected toward the lens portion 2r5 is converted into a collimated light by the lens portion 2r5, and is emitted toward the second mirror 3h. The collimated light emitted toward the second mirror 3h is converted into a converging light by the lens portion 3h5, and is reflected toward the second waveguide 3d by the reflecting surface 3h4. In the first mirror 2r and the second mirror 3h shown in FIG. 6, each of the reflecting surface 2r4 and the reflecting surface 3h4 acts as a convex mirror. Since the divergent light that is increased in beam diameter by the reflecting surface 2r4 is incident on the lens portion 2r5, the beam diameter of the collimated light can be made larger compared to the first mirrors 2k and 2q and the second mirrors 3f and 3g. Accordingly, the alignment tolerance between the optoelectronic substrate 2B and the optical IC 3B is improved, so that a decrease in optical coupling efficiency can be suppressed, and it becomes easier to realize high optical coupling efficiency between the optoelectronic substrate 2B and the optical IC 3B.

When the signal light L is output as a divergent light from the second waveguide 3d to the second mirror 3h inside the second recess 3c, the divergent light is increased in beam diameter by the reflecting surface 3h4 of the second mirror 3h, and is reflected toward the lens portion 3h5. The divergent light reflected toward the lens portion 3h5 is converted into a collimated light by the lens portion 3h5, and is emitted toward the first mirror 2r. The collimated light emitted toward the first mirror 2r is converted into a converging light by the lens portion 2r5, and is reflected toward the first waveguide 2j by the reflecting surface 2r4.

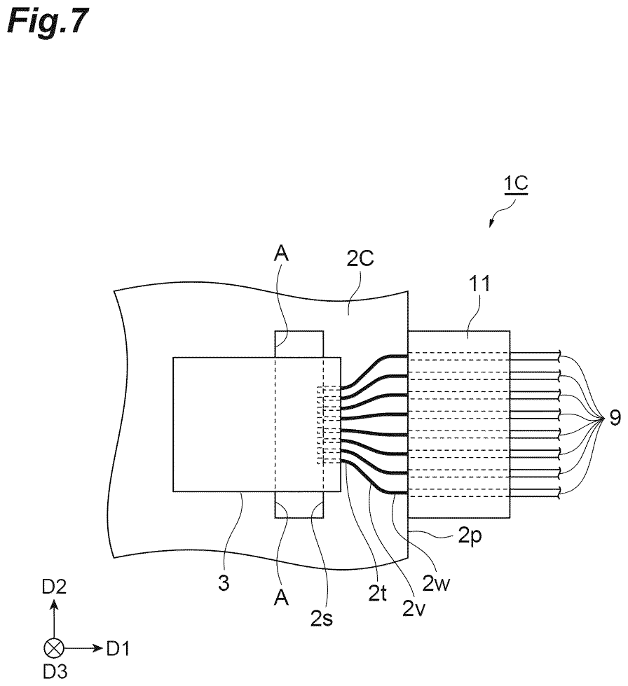

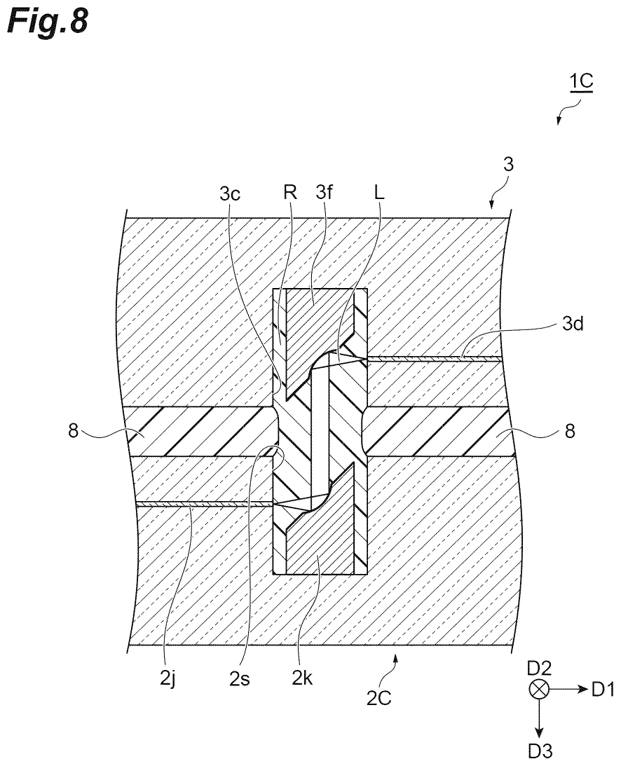

FIG. 7 is a plan view schematically showing an optoelectronic substrate 2C of an optical module 1C according to a third modification example. FIG. 8 is a cross-sectional view schematically showing the optoelectronic substrate 2C and the optical IC 3 of the optical module 1C. The optoelectronic substrate 2C includes a first recess 2s in which a region A exposed to the outside of the optical module 1C in a state where the optical IC 3 is mounted on the optoelectronic substrate 2C is formed. The region A located at an end portion of the first recess 2s in the second direction D2 is not covered by the optical IC 3. In the optical module 1C, the first recess 2s can be accessed through the region A from the outside of the optical module 1C.

In the optical module 1C, the first recess 2s can be filled with a matching resin R through the region A from the outside of the optical module 1C. The filling of the matching resin R is performed to suppress reflection of the signal light L at the interface between the glass and air or the interface between the resin and air. Further, by filling the first recess 2s with the matching resin R, the occurrence of dew condensation inside the first recess 2s and the entry of dust and the like into the first recess 2s can be suppressed, so that the reliability of optical coupling in the optoelectronic substrate 2C and the optical IC 3 can be improved. The matching resin R may be a curable resin or may be a non-curable resin. FIG. 7 shows an example in which both end portions of the first recess 2s in the second direction D2 are exposed to the outside of the optical module 1C. However, one side of the first recess 2s in the second direction D2 may be exposed to the outside of the optical module 1C.

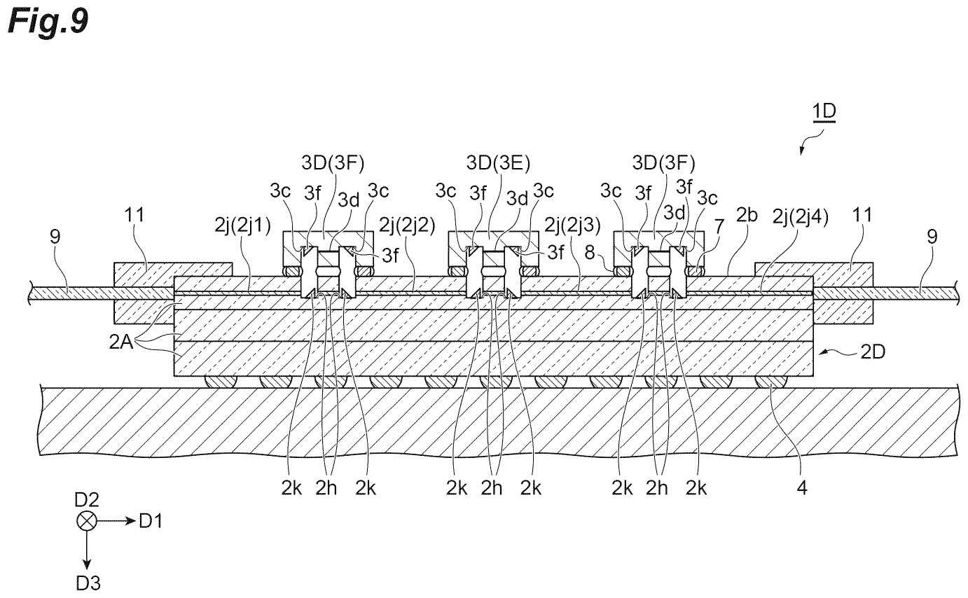

FIG. 9 is a cross-sectional view showing an optical module 1D according to a fourth modification example. As shown in FIG. 9, the optical module 1D includes an optoelectronic substrate 2D and an optical IC 3D. The optical module 1D includes a plurality of the optical ICs 3D. The plurality of optical ICs 3D include, for example, a light source 3E and a modulator 3F. As one example, the modulator 3F is disposed on each of both sides of the light source 3E in the first direction D1. However, the configuration of the plurality of optical ICs 3D is not limited to the above example, and can be changed as appropriate.

Each of the optical ICs 3D includes a plurality of the second recesses 3c. The optoelectronic substrate 2D includes a plurality of the first recesses 2h facing the plurality of respective second recesses 3c of one optical IC 3D along the third direction D3. The optoelectronic substrate 2D includes a plurality of the first waveguides 2j. Each of the plurality of first waveguides 2j extends along the first direction D1 between two first recesses 2h. The optoelectronic substrate 2D includes the plurality of first waveguides 2j extending toward the plurality of respective first recesses 2h, and a plurality of the first mirrors 2k formed inside the plurality of respective first recesses 2h. Each of the optical ICs 3D includes the second waveguide 3d extending between the plurality of second recesses 3c, and a plurality of the second mirrors 3f formed inside the respective second recesses 3c.

The plurality of first waveguides 2j are optically coupled to each other through the plurality of first mirrors 2k, the plurality of second mirrors 3f, and the second waveguide 3d. As a specific example, when a first waveguide 2j1, a first waveguide 2j2, a first waveguide 2j3, and a first waveguide 2j4 are arranged in order along the first direction D1, the first waveguide 2j1 is optically coupled to the first waveguide 2j2 through the first mirror 2k, the second mirror 3f of the modulator 3F, the second waveguide 3d of the modulator 3F, the second mirror 3f of the modulator 3F, and the first mirror 2k.

The first waveguide 2j2 is optically coupled to the first waveguide 2j3 through the first mirror 2k, the second mirror 3f of the light source 3E, the second waveguide 3d of the light source 3E, the second mirror 3f of the light source 3E, and the first mirror 2k. Then, the first waveguide 2j3 is optically coupled to the first waveguide 2j4 through the first mirror 2k, the second mirror 3f of the modulator 3F, the second waveguide 3d of the modulator 3F, the second mirror 3f of the modulator 3F, and the first mirror 2k. In such a manner, in the optical module 1D, optical coupling with various optical ICs 3D can be realized.

The embodiment and various modification examples of the optical module and the optoelectronic substrate according to the present disclosure have been described above. However, the optical module and the optoelectronic substrate according to the present disclosure are not limited to the embodiment or the modification examples described above, and may be further modified within the scope of the concept described in the claims. Namely, the configuration, shape, size, material, number, and disposition mode of each portion of the optical module and the optoelectronic substrate according to the present disclosure can be changed as appropriate within the scope of the concept.

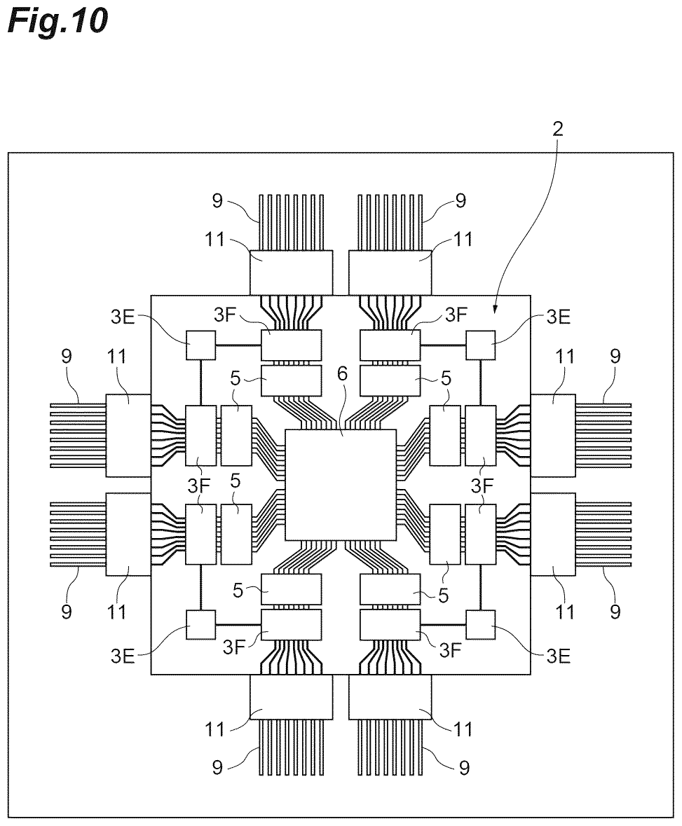

For example, in the fourth modification example described above, the optical module 1D including the plurality of optical ICs 3D in which the modulator 3F is disposed on each of both sides of the light source 3E in the first direction D1 have been described. However, as shown in FIG. 10, the optical module may be configured such that the light source 3E is disposed at each of four corners of the optoelectronic substrate 2 having a quadrangular shape in a plan view and each light source 3E is optically coupled to the modulators 3F adjacent thereto through the first waveguides 2j. In addition, in addition to the light sources, semiconductor optical amplifiers may be used. In such a manner, the number, disposition positions, and connection mode of the optical ICs mounted on the optoelectronic substrate of the optical module can be changed as appropriate.

In addition, for example, the optoelectronic substrate may be composed of one glass substrate. In this case, one or a plurality of wiring layers (rewiring layers or build-up layers) may be formed on at least one of the first surface and the second surface of the optoelectronic substrate. The pitch of the electrical wirings (for example, the terminals 4) of the wiring substrate 100 can be easily matched to the pitch of the electrical wirings (for example, the terminals 7) of the integrated circuits 10 by the one or plurality of wiring layers. For optical coupling between the 10 integrated circuits 10 and the first waveguides 2j, the wiring layers may be removed at locations where the first recesses 2h are formed.

What is claimed is:

1. An optical module comprising:
an optoelectronic substrate including a first surface, a first recess open on the first surface, a first waveguide extending toward the first recess, and a first mirror that is formed inside the first recess and that reflects a signal light transmitted through the first waveguide; and
an optical IC including a circuit surface facing the first surface, a second waveguide formed on the circuit surface, a second recess open on the circuit surface, and a second mirror that is formed inside the second recess and that reflects a signal light transmitted through the second waveguide, and connected to the optoelectronic substrate such that the circuit surface faces the first surface,
wherein the first waveguide and the second waveguide are optically coupled to each other through the first mirror and the second mirror.

2. The optical module according to claim 1,
wherein the optoelectronic substrate is configured by laminating a plurality of glass substrates,
the first surface is an upper surface of the glass substrate in an uppermost layer among the plurality of glass substrates, and
the first waveguide is formed in the glass substrate in the uppermost layer.

3. The optical module according to claim 1,
wherein the signal light is output from the first waveguide into the first recess, and the signal light is reflected toward the optical IC by the first mirror, and
the second mirror reflects the signal light, which is reflected by the first mirror, toward the second waveguide.

4. The optical module according to claim 3,
wherein the second mirror reflects the signal light such that a direction of the signal light propagating through the second waveguide becomes the same as a direction of the signal light propagating through the first waveguide.

5. The optical module according to claim 1,
wherein the optoelectronic substrate has an end face intersecting the first surface, and the first waveguide extends from the end face toward the first recess, and
the optical module further includes an optical fiber that is connected to the end face and that is optically coupled to the first waveguide.

6. The optical module according to claim 1,
wherein the optoelectronic substrate includes a plurality of the first recesses, a plurality of the first waveguides extending toward the plurality of respective first recesses, and a plurality of the first mirrors formed inside the plurality of respective first recesses,
the optical IC includes a plurality of the second recesses, the second waveguide extending between the plurality of second recesses, and a plurality of the second mirrors formed inside the plurality of respective second recesses, and
the plurality of first waveguides are optically coupled to each other through the plurality of first mirrors, the plurality of second mirrors, and the second waveguide.

7. An optoelectronic substrate connected to an optical IC, comprising:
a first surface facing a circuit surface of the optical IC;
a first recess open on the first surface;
a first waveguide extending toward the first recess; and
a first mirror that is formed inside the first recess, and that reflects a signal light transmitted through the first waveguide.

8. An optoelectronic substrate having a first surface and a second surface opposite to the first surface, the optoelectronic substrate comprising:
a first glass substrate having the first surface, a first recess, a first waveguide, a first mirror, and a first terminal, the first recess being open on the first surface, the first waveguide extending toward the first recess, the first mirror being formed inside the first recess and configured to reflect a signal light transmitted through the first waveguide, the first terminal being formed on the first surface;
a second glass substrate having the second surface and a second terminal formed on the second surface; and
a wiring path formed in the first glass substrate and the second glass substrate, the wiring path being configured to electrically connect the first terminal and the second terminal each other.
